(19) United States
(12) Patent Application Publication
(10) Pub. No.: US 2026/0353485 A1
(43) Pub. Date: Nov. 5, 2026

(54) EMLSR OVER P2P

(71) Applicant: APPLE INC., Cupertino, CA (US)

(72) Inventors: Oren Shani, Saratoga, CA (US); Yoel Boger, Shoham (IL); Yong Liu, Campbell, CA (US)

(21) Appl. No.: 19/558,846

(22) Filed: Mar. 6, 2026

Related U.S. Application Data
(60) Provisional application No. 63/798,141, filed on May 1, 2025.

(51) Int. Cl. H04W 76/14; H04L 5/00; H04W 8/22; H04W 74/00; H04W 74/0816

(52) U.S. Cl. CPC H04W 76/14; H04L 5/0053; H04W 8/22; H04W 74/002; H04W 74/0816

(57) ABSTRACT

Systems, methods, and apparatuses herein include embodiments for Enhanced Multi-Link Single Radio (EMLSR) over peer-to-peer (P2P). In some embodiments, an EMLSR Responder may send, to an initiator peer device, a request to enter EMLSR over peer-to-peer (P2P) session with the initiator peer device. The EMLSR Responder may receive, from the initiator peer device, a response accepting the request to enter EMLSR over P2P, and monitor EMLSR links for an Initial Control Frame (ICF) with padding or for a Request to Send (RTS) from the initiator peer device.

### TECHNICAL FIELD

This application relates generally to wireless communication systems, including configurations for Enhanced Multi-Link Single Radio (EMLSR) with a peer device.

### BACKGROUND

Wireless communication technology uses various standards and protocols to transmit data between an access point and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

In the 802.11 standard for WLAN, an access point (AP) is a device that creates a wireless local area network (WLAN), or Wi-Fi® network. It may be connected to a wired network, such as an Ethernet network, and provides wireless access to that network for other devices. A station is a device that is capable of being wirelessly connected to the AP to join the WLAN network. Stations can be laptops, smartphones, tablets, or any other device with a WLAN adapter.

APs and stations communicate with each other using the Wi-Fi® protocol. Various protocols have been established to increase security over a wireless communication network. For example, Simultaneous Authentication of Equals is the core authentication protocol of WPA3-Personal, and is mandated to be supported by all Wi-Fi® Alliance certified devices, including both access points (APs) and non-AP stations (STAs).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example block diagram of a device using EMLSR based communications over P2P in accordance with some embodiments.

FIG. 2A illustrates an example topology with a 5 GHz link dedicated to P2P and a 6 GHz link dedicated to Infra, in accordance with some embodiments.

FIG. 2B illustrates an example topology where a 5 GHz link is shared by P2P and Infra (on/off infra) and a 6 GHz link is dedicated to Infra, in accordance with some embodiments.

FIG. 2C illustrates an example topology where a 5 GHz link is dedicated to P2P (hopping) and a 6 GHz link is shared by P2P and Infra, in accordance with some embodiments.

FIG. 2D illustrates an example topology where a 5 GHz link is shared by P2P and Infra (on/off infra) and the 6 GHz link is shared by P2P and Infra, in accordance with some embodiments.

FIG. 3 illustrates an example Type-Length-Value (TLV 302) for EMLSR over P2P in accordance with some embodiments.

FIG. 4 illustrates an example signal flow diagram for an EMLSR Responder to enter EMLSR over P2P in accordance with some embodiments.

FIG. 5 illustrates an example signal flow diagram for an EMLSR Responder to exit EMLSR over P2P in accordance with some embodiments.

FIG. 6A illustrates an example signaling diagram for downlink transmission (e.g., receiving data from a peer device) using Single Link Power Save Mode over P2P in accordance with some embodiments.

FIG. 6B illustrates an example signaling diagram for uplink transmission (e.g., sending data to a peer device) using Single Link Power Save Mode over P2P in accordance with some embodiments.

FIG. 7A illustrates an example signaling diagram for Unicast Frames in EMLSR over P2P on Link 1, in accordance with some embodiments.

FIG. 7B illustrates an example signaling diagram for Unicast Frames in EMLSR over P2P on Link 2, in accordance with some embodiments.

FIG. 8 illustrates an example signaling diagram for Multicast Frames in EMLSR over P2P, in accordance with some embodiments.

FIG. 9 illustrates a method performed by an EMLSR Responder, in accordance with some embodiments.

FIG. 10 illustrates a method performed by an EMLSR Initiator, in accordance with some embodiments.

FIG. 11 illustrates a system for performing signaling between an EMLSR Responder and an EMLSR Initiator, according to embodiments disclosed herein.

### DETAILED DESCRIPTION

Wireless communication technology uses various standards and protocols to transmit data between an access point and a wireless communication device. One standard that is used for wireless communication is Institute of Electrical and Electronics Engineers (IEEE) 802.11 standard for Wireless Local Area Networks (WLAN) (commonly known to industry groups as Wi-Fi®). Wi-Fi® provides a convenient way to establish a network between devices. A device (e.g., a station) may connect to a Wi-Fi® access point to join a network and connect to the internet wirelessly. Wi-Fi® security is important to protect data and devices from unauthorized access.

Various embodiments are described with regard to a station (STA) and Access Point (AP). However, reference to a STA and AP is merely provided for illustrative purposes. The example embodiments may be utilized with any electronic component that may establish a connection to a network and is configured with the hardware, software, and/or firmware to exchange information and data with the network. Therefore, the STAs and APs as described herein are used to represent any appropriate electronic component.

As used herein, the following terms shall have the meanings set forth below.

These definitions are intended to clarify the terminology used in the present disclosure and are not intended to be limiting unless explicitly stated otherwise.

“P2P” refers to peer to peer direct Wi-Fi communication protocol (e.g., Apple Wireless Direct Link (AWDL)/Neighbor Awareness Networking (NAN)).

“EMLSR” refers to Enhanced Multi-Link Single Radio (e.g., as defined in 802.11be specifications).

“STR” refers to simultaneous Tx/Rx (e.g., as defined in 802.11be specifications).

“SDB” refers to Simultaneous Dual Band.

“ICF” refers to Initial Control Frame (e.g., a Multi-User Request to Send (muRTS) frame or a Buffer Status Report Poll (BSRP) frame, that include the receiving device(s) Association Identifier(s) (AID(s)) as part of the ICF User Info fields, with padding).

“ICF-Rsp frame” includes a Clear to Send (CTS)/Buffer Status Report (BSR) immediate response to muRTS/BSRP trigger frame.

“EMLSR Initiator” refers to a device entity initiating every TXOP to an EMLSR Responder with an ICF/ICF-Rsp. For example, an AP device acts as an EMLSR Initiator with an EMLSR STA.

“EMLSR Responder” refers to a device entity supporting reception of an ICF/ICF-Rsp transaction before every TXOP, on one or more EMLSR links, or reception of an RTS/CTS transaction before every TXOP on a single EMLSR link. For example, an EMLSR STA device acts as an EMLSR Responder with an AP.

“Legacy Initiator” refers to a device entity initiating every TXOP to an EMLSR Responder with an RTS/CTS (legacy).

“EMLSR Enabled device” refers to a device with WiFi7+ hardware support for EMLSR over P2P, which includes full support for STA EMLSR and in addition, being able to support EMLSR Initiator and EMLSR Responder, and can honor EMLSR transition delay.

“EMLSR Aware device” refers to a device that does not have full WiFi7 hardware support for EMLSR over P2P, but can become aware that it is communicating with an EMLSR Enabled device, and can be configured to operate as either a Legacy Initiator, or an EMLSR Initiator (if it can support initiating every TXOP with an ICF/ICF-Rsp).

“EMLSR Unaware device” refers to a device that does not have full hardware support for EMLSR over P2P, and does not support the EMLSR Aware or EMLSR Enabled device mode of operation.

Peer to peer use cases are having increasingly more challenging Key Performance Indicators (KPIs) to support, such as zero glitches in 10 hours in some use cases. As Wi-Fi uses a shared channel resource, and that resource may become occupied for extended durations (for example by CTS-to-self for up to 32 ms), the use of more than one channel (link) for those low latency use cases may be useful.

Implementations may leverage SDB capabilities to support multi-channel low latency P2P use cases, but this requires having radios on both channels turned on. EMLSR leverages a single main radio plus an additional low power scan radio (or uses a 1x1+1x1 configuration), which can help improve on the following aspects. First, EMLSR may have latency benefits. For example, EMSLR may allow for the ability to contend on both channels simultaneously and immediately transmit on the first channel that becomes available (policy based). Second, EMSLR may have power benefits. For example, EMSLR may allow for the ability to listen on and contend on two channels simultaneously with a main radio plus a low power scan radio, or on a single link with a low power scan radio.

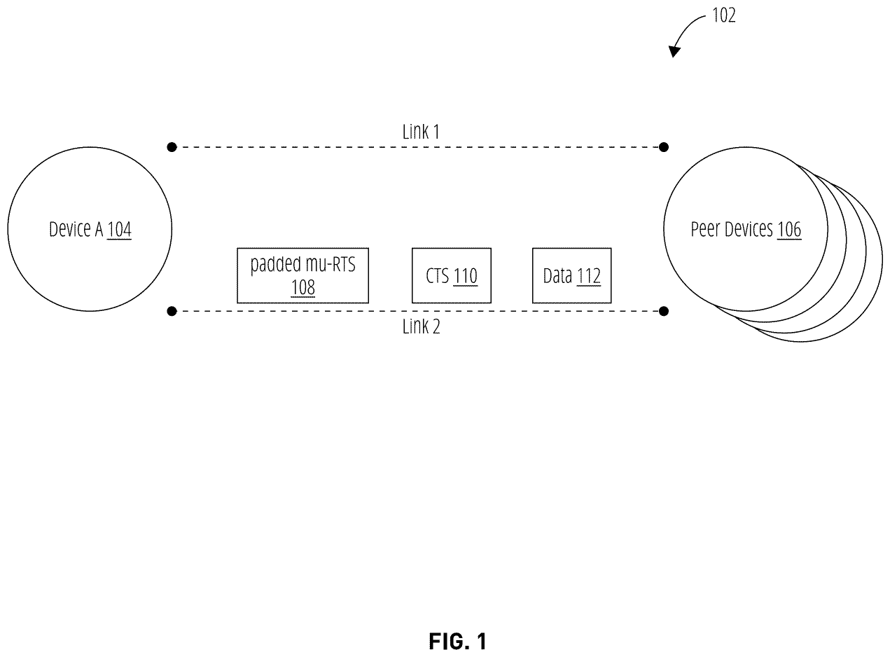

FIG. 1 illustrates an example block diagram 102 of a device using EMLSR based communications over P2P in accordance with some embodiments. FIG. 1 demonstrates the general concept of leveraging ICF as a means to have EMLSR based communications over P2P. As shown, device A 104 may have two links with one or more peer devices 106. Device A 104 may send the peer devices 106 an ICF (e.g., padded mu-RTS 108) to initiate a TXOP on link 2. In response, the peer devices 106 may send an ICF-Rsp frame (e.g., CTS 110). After the CTS 110, the device A 104 may send the data packet 112 over link 2.

This specification defines four types of peer devices 106 that device A 104 may encounter when attempting EMLSR based communications over P2P. Different functionality may be expected of different types or modes of the peer devices. For example, peer devices may include an EMLSR Unaware peer. Such a peer device does not support EMLSR over P2P.

Peer devices may include an EMLSR Aware peer. The EMLSR Aware peer may have pre-WiFi7 chipsets and therefore not include full hardware support. The EMLSR Aware peer may support Legacy Initiator mode of operation. The EMLSR Aware peer may support EML Operating Mode Notification frame. The EMLSR Aware peer may support In-Device Coexistence Activities subfield of the EML Control Field. If a Legacy Initiator does not receive a response to an RTS that it transmits to an EMLSR Responder, then the Legacy Initiator may consider the non-response as a result of the in-device coexistence at the EMLSR Responder on the link where the frame was transmitted. Such a peer may support EMLSR Aware device requirements defined herein.

Peer devices may include EMLSR Aware with ICF support peer. The EMLSR Aware with ICF support peer may have pre-WiFi7 chipsets and therefore not include full hardware support. Such a peer may support EMLSR Initiator mode of operation, with optionally honoring EMLSR transition delay. Such a peer may support EML Operating Mode Notification frame. Such a peer may support In-Device Coexistence Activities subfield of the EML Control Field. If an EMLSR Initiator does not receive a response to an ICF that it transmits to an EMLSR Responder, then the EMLSR Initiator may consider the non-response as a result of the in-device coexistence at the EMLSR Responder on the link where the frame was transmitted. Further, the peer device may support EMLSR Aware with ICF support device requirements defined herein.

Peer devices may include EMLSR Enabled peer. The EMLSR Enabled peer may include WiFi7+ chipsets. The EMLSR Enabled peer may support both EMLSR Initiator and EMLSR Responder modes of operation. The EMLSR Enabled peer may support In-Device Coexistence Activities subfield of the EML Control Field. If an EMLSR Initiator does not receive a response to an ICF that it transmits to an EMLSR Responder, then the EMLSR Initiator may consider the non-response as a result of the in-device coexistence at the EMLSR Responder on the link where the frame was transmitted. The EMLSR Enabled peer may support EMLSR Transition Delay after an EMLSR over P2P TXOP. The peer may support EMLSR Enabled device requirements defined herein.

WiFi7 EMLSR over P2P may use NAN as a baseline peer to peer protocol which supports more than one channel map ID configuration active at any given time. EMLSR over P2P is established between a pair of devices, where at least one of them is an EMLSR Enabled device. As EMLSR over P2P may use NAN as a baseline, any NAN topology may be used for EMLSR over P2P topology. When communicating with an EMLSR over P2P using a single link, AWDL can be used as well, as two channel maps are not required.

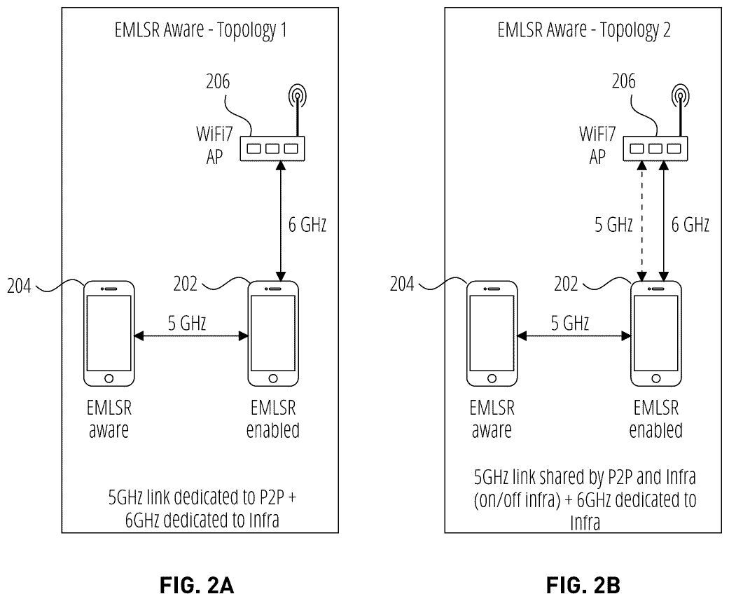

FIG. 2A, FIG. 2B, FIG. 2C, and FIG. 2D illustrate example topologies in which an EMLSR Enabled device can participate in concurrent EMLSR over P2P and EMLSR over infrastructure mode (Infra). The Topologies shown are examples to facilitate understanding of some scenarios of EMLSR over P2P may be utilized. Note that the presented topologies are non-exhaustive and serve as illustrative examples rather than a comprehensive representation.

Specifically, FIG. 2A illustrates an example topology with a 5 GHz link dedicated to P2P and a 6 GHz link dedicated to Infra, in accordance with some embodiments. As shown, the EMLSR enabled device 202 may be connected to an EMLSR aware device 204 over a 5 GHz link. Further, the EMLSR enabled device 202 may also be connected to the AP 206 over a 6 GHz link. The two links in the illustrated embodiment are established with EMLSR which can allow the EMLSR enabled device 202 to switch between the links with the different devices.

In this topology, there may be a Single Link EMLSR with WiFi7 AP 206. The Single Link EMLSR may be a dedicated 6 GHz Infra link as shown. Further, as shown, there may also be a single link legacy P2P link on the 5 GHz link, with channel hopping, including social channel.

The EMLSR enabled device 202 may maintain these links using two radios. In some embodiments, the EMLSR enabled device 202 may include a main radio and a scan radio. In other embodiments, the 202 may include two 1X1 main radios. The main radio or a 1X1 main radio may follow the P2P channel sequence. The EMLSR enabled device 202 may perform a quick switch to 6 GHz Infra link upon reception of ICF from AP 206 or for uplink to the AP 206. The scan radio or a 1X1 main radio may be used for listening on the Infra 6 GHz link for the ICF from the AP 206.

FIG. 2B illustrates an example topology where a 5 GHz link is shared by P2P and Infra (on/off infra) and a 6 GHz link is dedicated to Infra, in accordance with some embodiments. As shown, EMLSR enabled device 202 may have two links with the AP 206, and maintain a P2P link with the EMLSR aware device 204. The EMLSR may allow the EMLSR enabled device 202 to switch between the 5 GHz link and the 6 Ghz link to quickly send information to the AP. The 5 GHz link between the EMLSR enabled device 202 and the AP 206 may be active at certain times and inactive at other times based on the channel sequence of the 5 GHz channel.

In the illustrated embodiment, the EMLSR enabled device 202 maintains a dual link EMLSR with WiFi7 AP 206. The dual link between the EMLSR enabled device 202 and the AP 206 may include a dedicated 6 GHz Infra link and a 5 GHz Infra link that is shared with the P2P channel sequence. The 5 GHz Infra link may be put in power save when the P2P channel sequence leaves the 5 GHz Infra channel. Further, as shown, there may also be a single link legacy P2P link on the 5 GHz link, with channel hopping, including social channel.

The EMLSR enabled device 202 may maintain these links using two radios. In some embodiments, the EMLSR enabled device 202 may include a main radio and a scan radio. In other embodiments, the 202 may include two 1X1 main radios. The main radio or a 1X1 main radio may follow the P2P channel sequence. The EMLSR enabled device 202 may perform a quick switch to 6 GHz Infra link upon reception of ICF from AP 206 or for uplink to the AP 206. The scan radio or a 1X1 main radio may be used for listening on the Infra 6 GHz link for the ICF from the AP 206.

FIG. 2C illustrates an example topology where a 5 GHz link is dedicated to P2P (hopping) and a 6 GHz link is shared by P2P and Infra, in accordance with some embodiments. As shown, the EMLSR enabled device 202 may use EMLSR to maintain two links (e.g., 5 GHz and 6 GHz) with a second EMLSR enabled device 208, and the 6 GHz link may also be used for a link with the AP 206.

In the illustrated embodiment, the EMLSR enabled device 202 maintains a single link EMLSR with WiFi7 AP 206. For example, the 6 GHz Infra link may be shared with 6 GHz P2P. Further, a dual link EMLSR may be used with EMLSR Enabled peer device. In some embodiments, the 6 GHz channel sequence may always equal the 6 GHz Infra channel. The 5 GHz channel sequence can be set to any channel, including social channel.

The EMLSR enabled device 202 may maintain these links using two radios. In some embodiments, the EMLSR enabled device 202 may include a main radio and a scan radio. In other embodiments, the EMLSR enabled device 202 may include two IXI main radios. Main radio (or 1X1 main) and scan radio (or 1X1 main) can be on either of the links (channels) as needed. Social channels may call for having the main on those channels.

FIG. 2D illustrates an example topology where a 5 GHz link is shared by P2P and Infra (on/off infra) and the 6 GHz link is shared by P2P and Infra, in accordance with some embodiments. As shown, the EMLSR enabled device 202 may use EMLSR to maintain two links (e.g., 5 GHz and 6 GHz) with a second EMLSR enabled device 208, and two links (e.g., 5 GHz and 6 Ghz) with the AP 206. The 5 GHz link between the EMLSR enabled device 202 and the AP 206 may be active at certain times and inactive at other times based on the channel sequence of the 5 GHz channel.

In the illustrated embodiment, the EMLSR enabled device 202 maintains a dual link EMLSR with WiFi7 AP 206. A 6 GHz Infra link may be shared with 6 GHz P2P. A 5 GHz Infra link may be shared with 5 GHz P2P channel sequence. A 5 GHz Infra link may be put in power save when 5 GHz P2P channel sequence leaves the 5 GHz Infra channel.

The EMLSR enabled device 202 may maintain these links using two radios. In some embodiments, the EMLSR enabled device 202 may include a main radio and a scan radio. In other embodiments, the EMLSR enabled device 202 may include two 1X1 main radios. Main radio (or 1X1 main) and scan radio (or 1X1 main) can be on either of the links (channels) as needed. Social channels may call for having the main on those channels.

Table 1 includes a summary of possible Infra and P2P links and the actions of the radios based on the topologies illustrated in FIGS. 2A-2D.

TABLE 1

| | | | Main radio | Scan radio |
|---|---|---|---|---|
| Topology | | | (or 1 × 1 | (or 1 × 1 |
| Name | Infra | P2P | main) | main) |
| EMLSR | Single Link EMLSR with | Single link legacy P2P | Following the | Listening |
| aware 1 | WiFi7 AP. Dedicated 6 GHz | link on 5 GHz, channel | P2P channel | on the |
| | Infra link | hopping, including | sequence. Quick | Infra |
| | | social channel | switch to 6 GHz | 6 GHz |
| | | | Infra link upon | link |
| | | | reception of ICF | |
| | | | from AP or for | |
| | | | UL to AP. | |
| EMLSR | Dual link EMLSR with | Single link legacy P2P | Following the | Listening |
| aware 2 | WiFi7 AP. Dedicated 6 GHz | link on 5 GHz, channel | P2P channel | on the |
| | Infra link. 5 GHz Infra link | hopping, including | sequence. Quick | Infra |
| | is shared with the P2P | social channel | switch to 6 GHz | 6 GHz |
| | channel sequence. 5 GHz | | Infra link upon | link |
| | Infra link may be put in | | reception of ICF | |
| | power save when the P2P | | from AP or for | |
| | channel sequence leaves the | | UL to AP. | |
| | 5 GHz Infra channel. | | | |
| EMLSR | Single Link EMLSR with | Dual link EMLSR with | Main and scan can be on | |
| enabled 1 | WiFi7 AP. 6 GHz Infra link | EMLSR Enabled peer | either of the links | |
| | is shared with 6 GHz P2P. | device. 6 GHz channel | (channels) as needed. | |
| | | sequence is always | Social channels might call | |
| | | equal to 6 GHz Infra | for having the main on | |
| | | channel. 5 GHz channel | those channels. | |
| | | sequence can be set to | | |
| | | any channel, including | | |
| | | social channel. | | |
| EMLSR | Dual link EMLSR with | Dual link EMLSR with | | |
| enabled 2 | WiFi7 AP. 6 GHz Infra link | EMLSR Enabled peer | | |
| | is shared with 6 GHz P2P. | device. 6 GHz channel | | |
| | 5 GHz Infra link is shared | sequence is always | | |
| | with 5 GHz P2P channel | equal to 6 GHz Infra | | |
| | sequence. 5 GHz Infra link | channel. 5 GHz channel | | |
| | may be put in power save | sequence can be set to | | |
| | when 5 GHz P2P channel | any channel, including | | |
| | sequence leaves the 5 GHz | social channel. | | |
| | Infra channel. | | | |

To support EMLSR over P2P, there may be certain channel sequence conditions. When operating in EMLSR over P2P with EMLSR Enabled devices on two or more links, every pair of devices exchanging data in this mode may have the same channels defined for both links for the time slot being used for the EMLSR over P2P communications. The following are clarifications on multi-link EMLSR over P2P operation between two EMLSR Enabled devices.

First, the host can be able to configure multiple NAN MAP IDs in the 2.4/5/6 GHz bands. The host can also be able to configure a policy indicating a preference of which of these NAN MAP IDs the main radio(s) should prioritize (vs scan).

Second, before an EMLSR Initiator schedules a TXOP at a specific time slot, it can verify that the EMLSR Responder's channel sequence (in that time slot) includes the same set of channels that are being used for the multi-link EMLSR over P2P.

Third, each device advertises the NAN channel sequences. The device may advertise the NAN channel sequences via standard NAN protocol. A device is allowed to have additional channels, for example, a channel in the 2.4 GHz band while performing 5 GHz+6 GHz EMLSR over P2P. The EMLSR link combinations that can be used for the EMLSR over P2P operations are 2.4 GHz+5/6 GHz, 5/6 GHz+5/6 GHz, and 2.4 GHz+5/6 GHz+5/6 GHz combinations.

Fourth, if the multi-link channels for EMLSR over P2P of the EMLSR Initiator do not match all of the multi-link channels of the EMLSR Responder for the TXOP, the EMLSR Initiator may try to use a sub-set of the multi-link channels that do match, or if none of the channels match at all, the EMLSR Initiator cannot send packets to the EMLSR Responder at that time.

Fifth, NAN discovery, service discovery, sync frames, and the rest of the standard NAN protocol operations can be maintained in the 2.4 GHz social channel (channel 6).

Sixth, if an EMLSR Unaware device has setup an active data path with an EMLSR Responder device, the EMLSR Responder shall exit EMLSR over P2P with all peer devices it has requested to enter EMLSR over P2P with, until the communication with the EMLSR Unaware device is done (device caching has been removed/NDP has been removed).

When operating in EMLSR over P2P on a single link only, NAN or AWDL may be used, and devices can follow the regular AWDL/NAN behavior, including being discoverable, and including the social channel in the channel sequence as needed.

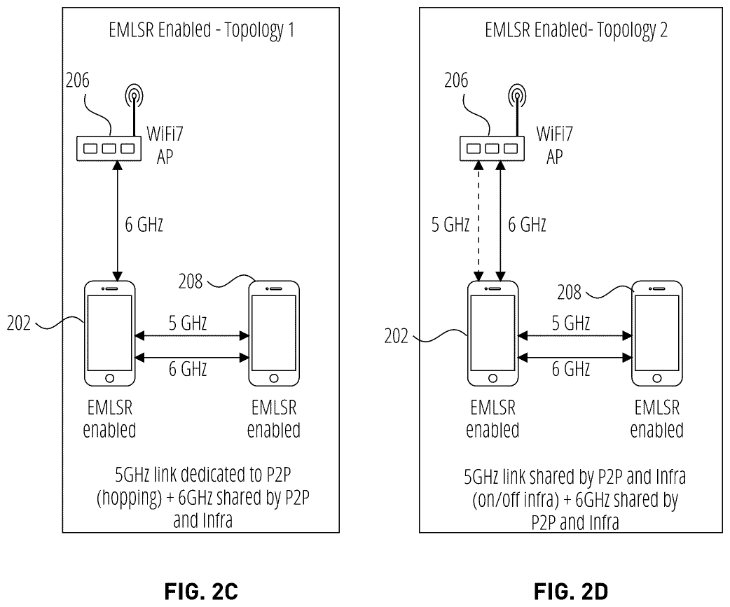

FIG. 3 illustrates an example Type-Length-Value (TLV 302) for EMLSR over P2P in accordance with some embodiments. The TLV 302 may be used to exchange EMLSR over P2P capabilities. For example, a device may send the information in the TLV to indicate its EMLSR over P2P capabilities and parameters. The TLV 302 may be added to specific frames. For example, in some embodiments, the TLV 302 may be added to AWDL master indication frames and sync frames, and NAN discovery and synchronization frames.

The TLV 302 may include a number of fields. The TLV 302 may include a type/tag number 304. The type/tag number 304 may be a unique value that identifies the TLV 302 as including information for EMLSR over P2P. The TLV 302 may further include a length field 306 that indicates the length of the TLV 302.

In some embodiments, the TLV 302 may include an EMLSR over P2P capabilities field 308. The EMLSR over P2P capabilities field 308 may indicate the capabilities of the device. For example, the EMLSR over P2P capabilities field 308 may be used to indicate whether the device is an EMLSR Aware device, EMLSR Enabled device, or an EMLSR Aware with ICF support device. For instance, a bit field may be used where each bit is associated with a different type of device and setting a bit to 1 indicates that the device sending the TLV is that device type.

The TLV 302 may include an EMLSR link bitmap field 310. The bits in the EMLSR link bitmap field 310 may be used to indicate channels that are available for or currently being used for EMLSR over P2P operation. For example, in the illustrated embodiment, the bitmap includes 8 bits (e.g., bit[0-7]). A device sending the TLV 302 may set bit N to 1 to indicate that NAN MAP ID[N] are available for or currently being used for EMLSR over P2P operation. Note that for AWDL, only bit[0] value may be relevant.

The TLV 302 may include an EMLSR Responder unicast AID field 312. The EMLSR Responder unicast AID field 312 may indicate the AID that the device will listen for in the User Info Field of the ICF, if it is an EMLSR Enabled device. In some embodiments, the EMLSR Responder unicast AID field 312 may have a range of 1-4095. A new random AID may be generated each time (and together with) the P2P MAC address is rotated.

The TLV 302 may include an EMLSR parameters field 314. The EMLSR parameters field 314 may include parameters for the device. For example, the EMLSR parameters field 314 may indicate a transition timeout, EMLSR padding delay, and whether EMLSR Responder mode is on or off.

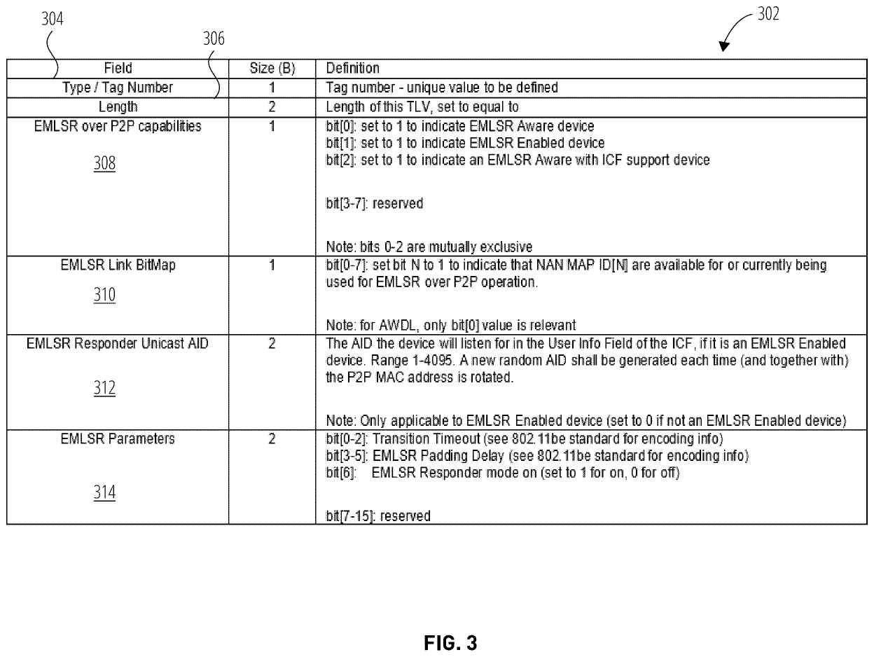

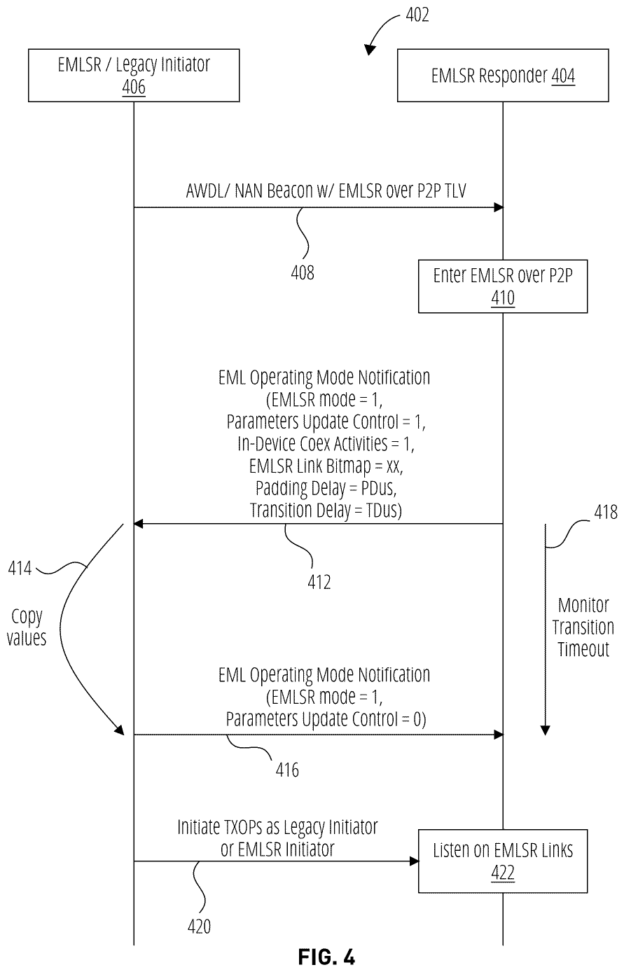

A request to Enter EMLSR over P2P mode may be initiated by an EMLSR Responder (by an EMLSR Enabled device), and accepted or rejected by an EMLSR Initiator/Legacy Initiator. An EMLSR Responder may indicate the need for an ICF with padding or for legacy RTS, and which links it would be listening on, along with the rest of the parameters, as described in more detail below (e.g., FIG. 4 and FIG. 5). If a pair of devices would like to setup a bi-directional EMLSR over P2P, they may both initiate the Enter EMLSR procedure from their EMLSR Responder side.

FIG. 4 illustrates an example signal flow diagram 402 for an EMLSR Responder to enter EMLSR over P2P in accordance with some embodiments. As shown, an EMLSR Initiator 406 (or Legacy Initiator) may transmit an AWDL or NAN beacon 408 to the EMLSR Responder 404. The beacon 408 may include EMLSR over P2P TLV (e.g., TLV 302 of FIG. 3). The EMLSR over P2P TLV may indicate the EMLSR over P2P capabilities of the EMLSR Initiator 406.

WiFi7 standard defines using EML Operating Mode Notification as a request/response pair sent by an EMLSR Responder (e.g., a STA) to an EMLSR Initiator (e.g., an AP), this concept may be maintained for EMLSR over P2P, where the EMLSR Parameter Update Control bit may be set to 1 when a request is made, and may be set to 0 when a response is sent. Thus, the EMLSR Parameter Update Control bit may be used by the EMLSR Responder and the EMLSR Initiator to indicate whether a EML operating mode notification is a request to enter or exit EMLSR over P2P or a response to a request.

The EMLSR Responder 404 may initiate an enter EMLSR over P2P 410 procedure by sending an EML operating mode notification frame 412. In some embodiments, the EMLSR Responder 404 may initiate the Enter EMLSR over P2P 410 flow with a peer device only after having received the values in the TLV for EMLSR over P2P from the peer device (e.g., EMLSR over P2P TLV in beacon 408). In some embodiments, Enter EMLSR over P2P 410 can be requested by an EMLSR Enabled device only.

The EML operating mode notification frame 412 may include information for the EMLSR over P2P. For example, the EML operating mode notification frame 412 may include an EMLSR mode field, a parameter update control field, an in-device coexistence activities subfield, an EMLSR link bitmap, padding delay field, and transition delay field. The EMLSR mode field may indicate whether the EMLSR Responders 404 is requesting to exit or enter EMLSR over P2P. For example, in the illustrated embodiment, EMLSR mode field is set to 1 to indicate that EMLSR Responder 404 is entering EMLSR over P2P, and EMLSR mode field may be set to 0 to indicate that the EMLSR Responder 404 is exiting EMLSR over P2P. The parameter update control field may be used to indicate whether the EML operating mode notification frame 412 is a request to enter/exit EMLSR over P2P or a response. For example, the EMLSR Parameter Update Control bit may be set to 1 when a request is made, and may be set to 0 when a response is sent. The in-device coexistence activities subfield of the EML Control field may be set to 1 to indicate that it may have in-device Coexistence activities on the EMLSR links. This is useful for supporting P2P+Infra topologies. The EMLSR link bitmap may indicate that NAN MAP ID[N] are available for or currently being used for EMLSR over P2P operation. The padding delay field may indicate the padding delay, and the transition delay field may indicate the transition delay.

Thus, when an EMLSR Responder 404 would like to Enter EMLSR over P2P 410 with an EMLSR Initiator 406 or a Legacy Initiator, it may send an EMLSR EML operating mode notification frame 412 as follows. When an EMLSR Responder 404 initiates an Enter EMLSR over P2P 410 procedure, the EMLSR Responder 404 may send an EMLSR EML operating mode notification frame 412 to the EMLSR Initiator 406 or a Legacy Initiator, with EMLSR mode bit set to 1 and the EMLSR Parameter Update Control bit set to 1, in order to provide the EMLSR parameters for the request.

The EMLSR Responder 404 may send an EMLSR EML operating mode notification frame 412 that the EMLSR Initiator 406 or Legacy Initiator is capable of supporting. For example, it should not send a request to use two EMLSR links to an EMLSR Aware device or an EMLSR Aware device with ICF support, as those devices cannot support more than one EMLSR link. The EMLSR Responder 404 may determine the capabilities of the EMLSR Initiator 406 or Legacy Initiator based on the beacon 408 with EMLSR over P2P TLV.

If the EMLSR Initiator 406 or Legacy Initiator accepts the request, it may reply with an EMLSR EML Operating Mode Notification frame 416, in which the EMLSR mode bit is set to 1 in the EML control field, and the EMLSR Parameter Update Control bit is set to 0, as shown. The EMLSR mode bit being set to 1 in the EML control field may indicate that the EML operating mode notification frame 416 is a request to enter EMLSR over P2P, and the EMLSR Parameter Update Control bit being set to 0 may indicate that the EML operating mode notification frame 416 is a response to the request of the EML operating mode notification frame 412. The EMLSR Initiator 406 or Legacy Initiator may copy values 414 from the EML operating mode notification frame 412 and include them in the EML operating mode notification frame 416.

In some embodiments, if the EMLSR Initiator 406 or Legacy Initiator cannot accept the request (e.g., EML operating mode notification frame 412), it may reply with an EMLSR Operating Mode Notification frame, in which the EMLSR mode bit is set to 0 in the EML control field and the EMLSR Parameter Update Control bit is set to 0.

The Monitor Transition Timeout 418 may be followed to keep track of the request/response max timeout duration. The EMLSR Initiator 406 or Legacy Initiator may advertise their Monitor Transition Timeout values in the TLV for EMLSR over P2P. In case the timeout value has expired without receiving a response, the request may be assumed to have failed. If the request is assumed to have failed, the EMLSR Responder 404 may stop EMLSR over P2P until a successful request is made.

After receiving the EML operating mode notification frame 416 from the EMLSR Initiator 406, the EMLSR Responder 404 may listen on EMLSR links 422 for an ICF from the EMLSR Initiator 406 to initiate a TXOP. For example, in the illustrated embodiment, the EMLSR Initiator 406 sends an ICF 420 to initiate TXOP.

FIG. 5 illustrates an example signal flow diagram 502 for an EMLSR Responder 506 to exit EMLSR over P2P in accordance with some embodiments. When an EMLSR Responder 506 would like to Exit EMLSR over P2P 508 with an EMLSR Initiator or a Legacy Initiator, the EMLSR Responder 506 may send an EMLSR EML operating mode notification frame 510 as follows.

The EMLSR Responder 506 may send the EMLSR EML operating mode notification frame 510 with the EMLSR mode bit set to 0, and EMLSR Parameter Update Control bit is set to 1, as shown. The EMLSR mode bit being set to 0 may indicate that the EML operating mode notification frame 510 is associated with exiting EMLSR over P2P, and the EMLSR Parameter Update Control bit being set to 1 may indicate that the EML operating mode notification frame 510 is a request not a response.

The EMLSR Initiator 504 or Legacy Initiator may reply with an EMLSR EML operating mode notification frame 512, in which the EMLSR mode bit is set to 0 in the EML control field (indicating that the frame is related to exiting EMSLR over P2P), and the EMLSR Parameter Update Control bit is set to 0 (indicating that the frame is a response).

The Monitor Transition Timeout 514 may be followed to keep track of the request/response max timeout duration. The EMLSR Initiator 504 or Legacy Initiator may advertise their Monitor Transition Timeout values in the TLV for EMLSR over P2P. In case the timeout value has expired without receiving a response, the request shall be assumed to have succeeded. Accordingly, if the request is assumed to have failed, the EMLSR Responder 506 may stop EMLSR over P2P.

An EMLSR Responder may wish to make updates to an established EMLSR over P2P session. To make an update, the procedure to Enter EMLSR over P2P can be performed (e.g., signal flow diagram 402 from FIG. 4), without requiring to first perform the Exit EMLSR over P2P procedure.

In some embodiments, EMLSR over P2P may be used for power savings. For example, a single link power save mode over P2P may be used. An EMLSR Responder may request to Enter EMLSR over P2P on a single link power save mode with an EMLSR Initiator, which can either be an EMLSR Enabled device or an EMLSR Aware device with ICF support. Honoring EMLSR transition delay may not be required for this mode of operation, as the scan radio/auxiliary radio (or 1x1 main) may be continuously listening on the channel.

This mode may include setting up a single link EMLSR over P2P. This would allow an EMLSR Responder to listen on the single EMLSR over P2P channel with an auxiliary radio/scan radio (or 1x1 main) radio, and quickly switch to the full main radio mode of operation either upon reception of an ICF from the EMLSR Initiator, or for transmitting uplink frames to the peer device.

In some embodiments, this mode of operation (EMLSR single link power save mode over P2P) can work on top of NAN or AWDL, since it only uses a single link. The scan radio/auxiliary radio (or 1x1 main radio) may be listening on the P2P channel sequence, to reduce listen power consumption, instead of the full main radio. On social channel slots (for discovering AWDL/NAN devices and services, and accepting new NDP connections/subscriptions from EMLSR Unaware devices as well), a main radio may be used to listen on the social channel slots (host configured policy).

On infra channel slots, if the AP is WiFi7+ AP, scan/aux (or lxi main) radio can be used to listen for ICF from both P2P and Infra. If the AP is pre-WiFi7, the full main radio may be used whenever the Infra connection is not in power save. On any other channel slots (not social or Infra), the auxiliary radio/scan radio (or 1x1 main radio) can be used to listen for ICF from the EMLSR Initiator.

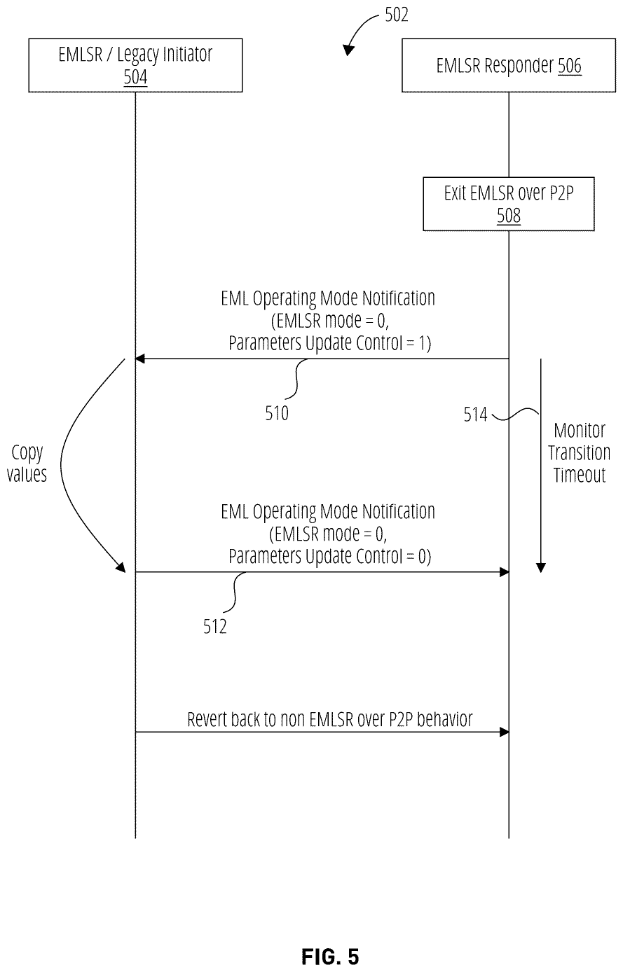

FIG. 6A illustrates an example signaling diagram 602 for downlink transmission (e.g., receiving data from a peer device) using Single Link Power Save Mode over P2P in accordance with some embodiments. In the illustrated embodiment, the EMLSR Enabled device establishes a link with a peer device using EMLSR over P2P. The EMLSR Enabled device uses a scan radio 604 and a main radio 606 to maintain the link.

In the beginning, the scan radio 604 is being used to monitor the link and the main radio 606 is off. When the peer device has something to send to the EMLSR Enabled device, the peer device sends an ICF (e.g., MU-RTS 608). The MU-RTS 608 may have sufficient padding to allow the EMLSR Enabled device to turn on the main radio and respond based on the SIFS.

The EMLSR Enabled device turns on the main radio and may respond to the MU-RTS 608 using the main radio with a MU-CTS 610. The peer device may then send the downlink data 612, and the EMLSR Enabled device may receive the downlink data 612 with the main radio. After the data is received, the EMLSR Enabled device may turn off the main radio and return to monitoring the link with the scan radio.

FIG. 6B illustrates an example signaling diagram 616 for uplink transmission (e.g., sending data to a peer device) using Single Link Power Save Mode over P2P in accordance with some embodiments. In the illustrated embodiment, the EMLSR Enabled device establishes a link with a peer device using EMLSR over P2P. The EMLSR Enabled device uses a scan radio 604 and a main radio 606 to maintain the link.

The scan radio 604 may be used to contend for a channel. Then when a back off timer reaches 0, the EMLSR Enabled device may turn on the main radio 606 and send uplink data 614 to the peer device. After the uplink data 614 is sent, the EMLSR Enabled device may turn off the main radio, and return to monitoring the link with the scan radio.

In some situations, an EMLSR Enabled device may be currently in an EMLSR over P2P session and a new peer device (e.g., not involved in the current EMLSR over P2P session) may desire to communicate with the EMLSR Enabled device. The EMLSR Enabled device may advertise using a TLV that it is in an EMLSR over P2P session, and the new peer device may take appropriate action to initiate communication (e.g., send an ICF).

If an EMLSR Enabled device is currently in an EMLSR over P2P session, and a new device would like to initiate communication with it, the EMLSR Enabled device may enter EMLSR over P2P with the new device as soon as possible after having accepted the communication with that peer. Entering into EMLSR over P2P with the new device may happen after having cached the new peer locally (for example in AWDL); after having received a unicast subscribe message with which a unicast publish message will be replied; or after having accepted NDP setup from the new peer device.

In embodiments that implement NAN, unicast subscribe and NDP setup messages could be sent to a device that is currently in an EMLSR over P2P session. For EMLSR Aware, EMLSR Aware with ICF support, and EMLSR Enabled devices, if they see that the peer device has EMLSR Responder mode turned on, as advertised in the new TLV (e.g., TLV 302 of FIG. 3) for EMLSR over P2P, they may send these unicast messages either as a Legacy Initiator (EMLSR Aware devices) or an EMLSR Initiator (EMLSR Aware with ICF support devices, EMLSR Enabled devices). In the case of EMLSR Initiator, the EMLSR Padding Delay indicated in the new TLV for EMLSR over P2P may be used, and EMLSR Transition Delay does not need to be honored. This may apply to unicast messages being sent on the NAN MAP IDs indicated in the new TLV for EMLSR over P2P as being used for EMLSR over P2P. Broadcast messages (such as broadcast subscribe), can be sent normally.

In embodiments that implement AWDL, for EMLSR Aware, EMLSR Aware with ICF support, and EMLSR Enabled devices, if they see that the peer device has EMLSR Responder mode turned on, as advertised in the new TLV for EMLSR over P2P, they may send initial unicast frames to the peer either as a Legacy Initiator (EMLSR Aware devices) or an EMLSR Initiator (EMLSR Aware with ICF support devices, EMLSR Enabled devices). In the case of EMLSR Initiator, the EMLSR Padding Delay indicated in the new TLV for EMLSR over P2P may be used, and EMLSR Transition Delay does not need to be honored. Broadcast messages can be sent normally.

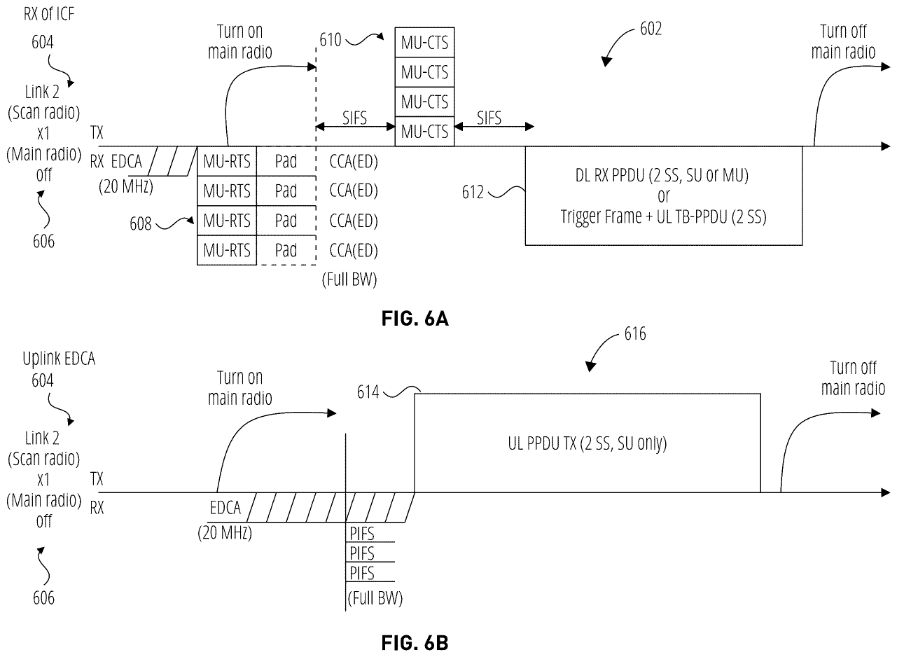

FIG. 7A and FIG. 7B show examples of an EMLSR Initiator sending unicast (non-group addressed) frames to an EMLSR Responder, on either of the two EMLSR over P2P links that have been established. The padded muRTS may include the AID of the EMLSR Responder in the User Info Field, and include the necessary padding duration required by the EMLSR Responder. Note that an MLD MAC address can be used when addressing P2P devices with EMLSR over P2P. When sending unicast frames in EMLSR over P2P, the ICF frame may be a unicast frame. The EMLSR Responder may check the receiver address (RA) and AID fields in the ICF frame as a condition for replying with a CTS.

FIG. 7A illustrates an example signaling diagram 702 for Unicast Frames in EMLSR over P2P on Link 1, in accordance with some embodiments. In the illustrated example, the EMLSR Initiator monitors both link 1 and link 2 for a back off period and determines that link 1 is clear first. Accordingly, the EMLSR Initiator may pursue the next steps on link 1.

As shown, the EMLSR Initiator may send an ICF (e.g., padded mu-RTS 704) to the EMLSR Responder to indicate it has data to send and give the EMLSR Responder sufficient time to turn on the main radio. The padded muRTS may include the AID of the EMLSR Responder in the User Info Field, and include the necessary padding duration required by the EMLSR Responder. Note that MLD MAC address may be used when addressing P2P devices with EMLSR over P2P.

The EMLSR Responder may respond to the padded mu-RTS 704 with a CTS 706 with the main radio to indicate that the EMLSR Responder is ready to receive. The EMLSR Initiator may send the data packet 708, and the EMLSR Responder may send a BA 710.

FIG. 7B illustrates an example signaling diagram 720 for Unicast Frames in EMLSR over P2P on Link 2, in accordance with some embodiments. In the illustrated example, the EMLSR Initiator monitors both link 1 and link 2 for a back off period and determines that link 2 is clear first. Accordingly, the EMLSR Initiator may pursue the next steps on link 2.

As shown, the EMLSR Initiator may send an ICF (e.g., padded mu-RTS 712) to the EMLSR Responder to indicate it has data to send and give the EMLSR Responder sufficient time to turn on the main radio. The padded muRTS may include the AID of the EMLSR Responder in the User Info Field, and include the necessary padding duration required by the EMLSR Responder. Note that MLD MAC address may be used when addressing P2P devices with EMLSR over P2P.

The EMLSR Responder may respond to the padded mu-RTS 712 with a CTS 714 with the main radio to indicate that the EMLSR Responder is ready to receive. The EMLSR Initiator may send the data packet 716, and the EMLSR Responder may send a BA 718.

Table 2 includes a summary of expected initiator behaviors when the initiator sends unicast frames in EMLSR over P2P.

TABLE 2

| | |
|---|---|
| Unicast EMLSR | EMLSR Enabled Responder |
| over P2P Behavior | |
| EMLSR Aware | Legacy Initiator may send an RTS at the |
| Initiator | beginning of a TXOP to the EMLSR Responder. |
| (Legacy Initiator) | |
| EMLSR Aware | EMLSR Initiator may send an ICF at the |
| with ICR | beginning of a TXOP to the EMLSR Responder |
| Support Initiator | EMLSR Initiator may optionally observe the |
| | EMLSR transition delay of the EMLSR Responder |
| | This mode of operation can be helpful in |
| | single link power save mode |
| EMLSR Enabled | EMLSR Initiator may send an ICF at the |
| Initiator | beginning of a TXOP to the EMLSR Responder |
| | EMLSR Initiator may observe the EMLSR |
| | transition delay of the EMLSR Responder |

As shown in Table 2, in some embodiments a Legacy Initiator (e.g., EMLSR Aware Initiator (Legacy Initiator)) may send an RTS at the beginning of a TXOP to the EMLSR Responder.

For an EMLSR Aware with ICR Support Initiator, the EMLSR Initiator may send an ICF at the beginning of a TXOP to the EMLSR Responder. EMLSR Initiator may optionally observe the EMLSR transition delay of the EMLSR Responder. This mode of operation can be helpful in single link power save mode.

For an EMLSR Enabled Initiator, the EMLSR Initiator may send an ICF at the beginning of a TXOP to the EMLSR Responder. The EMLSR Initiator may observe the EMLSR transition delay of the EMLSR Responder.

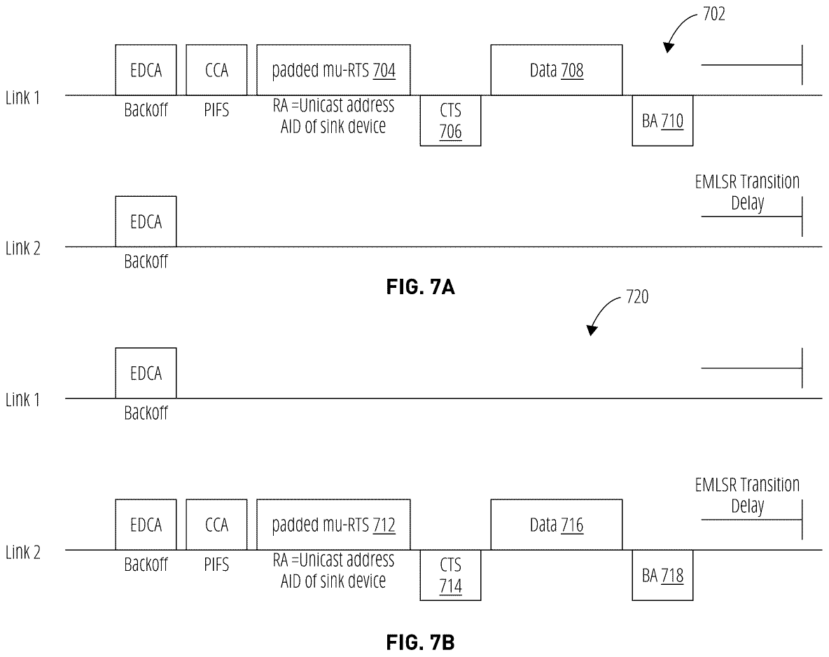

FIG. 8 illustrates an example signaling diagram 802 for Multicast Frames in EMLSR over P2P, in accordance with some embodiments. The illustrated embodiment shows an example of an EMLSR Initiator sending GCR-BA frames (e.g., GCR-BA Sequence 804) to multiple EMLSR Responders, on either of the two EMLSR over P2P links that have been established. In the illustrated example, the EMLSR Initiator monitors both link 1 and link 2 for a back off period and determines that link 1 is clear first. Accordingly, the EMLSR Initiator may pursue the next steps on link 1.

The EMLSR Initiator may perform CCA 808. The EMLSR Initiator may send an ICF (e.g., padded mu-RTS 806) to the EMLSR Responders to indicate it has data to send and give the EMLSR Responders sufficient time to turn on their main radios. The padded mu-RTS 806 may include the AID of each of the EMLSR Responders in the User Info Field, and include the largest duration required by the EMLSR Responders.

The EMLSR Responders that receives the padded mu-RTS 806 may send the EMLSR Initiator a CTS 810. The CTS 810 of the EMLSR Responders may be overlapping identical CTS frames. When the initiator receives the CTS 810, it may send the Multicast Data 812. The EMLSR Initiator and the EMLSR Responders may engage in a Groupcast with Retries Block Acknowledgment (GCR-BA) Sequence 804 where to confirm which EMLSR Responders successfully received the Multicast Data 812. An EMLSR transition delay may allow time for radios to transition to their original state.

In some embodiments, all devices participating in the GCR-BA session with EMLSR over P2P are EMLSR Enabled. In some embodiments, the sequence is aborted if no CTS response (sent by any of the receivers) was detected. In some embodiments, EMLSR over P2P is established between the source and each of the sink devices, pair by pair. In some embodiments, each sink device may check the RA and AID fields in the ICF frame as a condition for replying with a CTS.

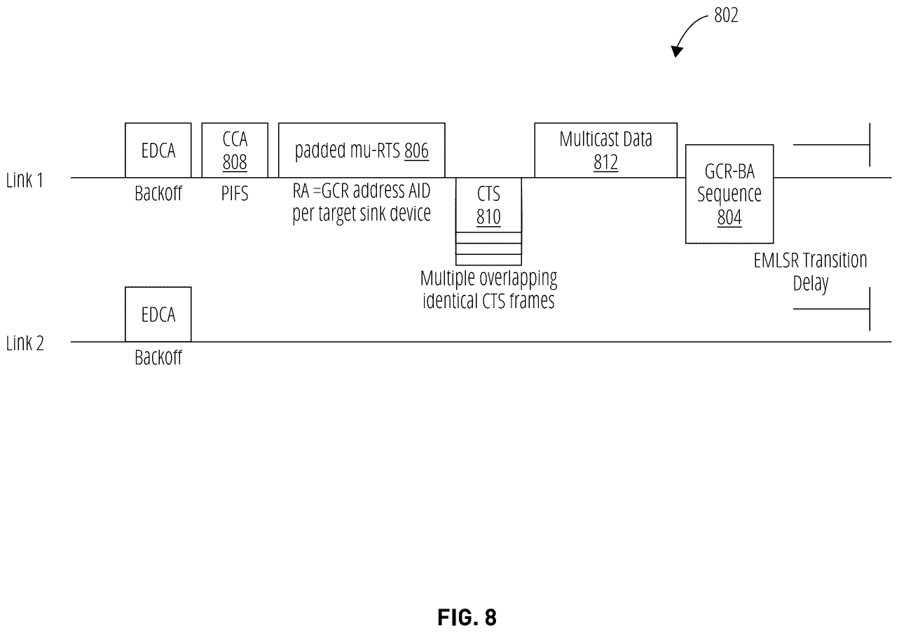

FIG. 9 illustrates a method 900 performed by an EMLSR Responder, in accordance with some embodiments. The illustrated method 900 includes sending 902, to an initiator peer device, a request to enter an EMLSR over P2P session with the initiator peer device. The method 900 further includes receiving 904, from the initiator peer device, a response accepting the request to enter the EMLSR over P2P session. The method 900 further includes monitoring 906 one or more EMLSR links for at least one of an ICF with padding or an RTS from the initiator peer device.

In some embodiments of the method 900, the request comprises a first EML Operating Mode Notification frame, the first EML Operating Mode Notification frame comprising: an EMLSR mode field that indicates the first EML Operating Mode Notification frame corresponds to entering the EMLSR over P2P session, an EMLSR Parameter Update Control field set to a first value that indicates the first EML Operating Mode Notification frame comprises the request, an In-Device Coexistence Activities subfield that indicates one or more in-device Coexistence activities on the EMLSR links, an EMLSR link bitmap, a padding delay field, and a transition delay field. In some such embodiments, the response comprises a second EML Operating Mode Notification frame comprising: an EMLSR mode field that indicates the first EML Operating Mode Notification frame corresponds to entering the EMLSR over P2P session, and an EMLSR Parameter Update Control field set to a second value that indicates the second EML Operating Mode Notification frame comprises the response.

In some embodiments, the method 900 further comprises sending, to the initiator peer device, a request to exit the EMLSR over P2P session that comprises an EML Operating Mode Notification frame comprising: an EMLSR mode field that indicates the EML Operating Mode Notification frame corresponds to exiting the EMLSR over P2P session, and an EMLSR Parameter Update Control field set to a first value that indicates the first EML Operating Mode Notification frame comprises a request.

In some embodiments, the method 900 further comprises receiving, from the initiator peer device, an EMLSR over P2P TLV that includes at least one of: an EMLSR over P2P capabilities field that indicates one or more capabilities of the initiator peer device, an EMLSR Link bitmap that indicates one or more links available for, or currently being used for, EMLSR over P2P operation, an EMLSR Responder Unicast AID, or an EMLSR Parameter.

In some embodiments, the method 900 further comprises entering the EMLSR over P2P session using a single link power save mode with the initiator peer device.

In some embodiments, the method 900 further comprises advertising, via a TLV, that the EMLSR Responder is in an EMLSR over P2P mode, indicating that an other device shall send an initial unicast frame to the EMLSR Responder before sending a data packet.

In some embodiments, the method 900 further comprises receiving a unicast frame from the initiator peer device, wherein receiving the unicast frame comprises: receiving, from the initiator peer device, a padded muRTS frame comprising: an AID of the EMLSR Responder in a User Info Field, and a padding duration associated with the EMLSR Responder; sending, to the initiator peer device, a CTS frame in response to the AID being included in the padded muRTS frame; and receiving, from the initiator peer device, data of the unicast frame.

In some embodiments of the method 900, receiving a multicast frame from the initiator peer device, wherein receiving the multicast frame comprises: receiving, from the initiator peer device, a padded muRTS frame comprising: a plurality of AIDs, in the User Info Field, corresponding to a plurality of EMLSR Responders; sending, to the initiator peer device, a CTS frame in response to an AID corresponding to the EMLSR Responder being included in the plurality of AIDs; and receiving, from the initiator peer device, multicast data.

In some embodiments of the method 900, updating the EMLSR over P2P session by sending an EML Operating Mode Notification frame comprising: an EMLSR mode field that indicates the first EML Operating Mode Notification frame corresponds to entering the EMLSR over P2P session, an EMLSR Parameter Update Control field set to a first value that indicates the first EML Operating Mode Notification frame is the request, and an updated parameter.

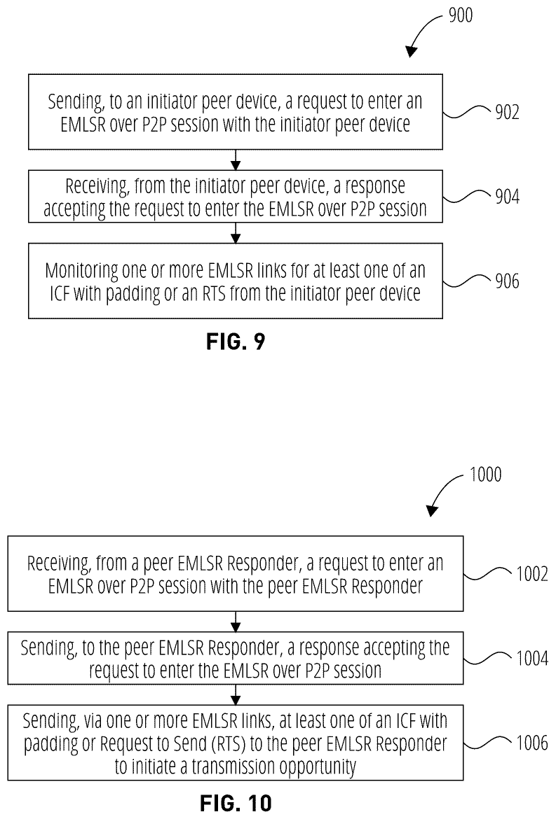

FIG. 10 illustrates a method 1000 performed by an EMLSR Initiator, in accordance with some embodiments. The illustrated method 1000 includes receiving 1002, from a peer EMLSR Responder, a request to enter an EMLSR over P2P session with the peer EMLSR Responder. The method 1000 further includes sending 1004, to the peer EMLSR Responder, a response accepting the request to enter the EMLSR over P2P session. The method 1000 further includes sending 1006, via one or more EMLSR links, at least one of an ICF with padding or a Request to Send (RTS) to the peer EMLSR Responder to initiate a transmission opportunity.

In some embodiments of the method 1000, the request comprises a first EML Operating Mode Notification frame, the first EML Operating Mode Notification frame comprising: an EMLSR mode field that indicates the first EML Operating Mode Notification frame corresponds to entering the EMLSR over P2P session, an EMLSR Parameter Update Control field set to a first value that indicates the first EML Operating Mode Notification frame comprises the request, an In-Device Coexistence Activities subfield that indicates in-device Coexistence activities on the EMLSR links, an EMLSR link bitmap, a padding delay field, and a transition delay field. In some such embodiments, the response comprises a second EML Operating Mode Notification frame comprising: an EMLSR mode field that indicates the first EML Operating Mode Notification frame corresponds to entering the EMLSR over P2P session, and an EMLSR Parameter Update Control field set to a second value that indicates the second EML Operating Mode Notification frame comprises the response.

In some embodiments, the method 1000 further comprises receiving, from the peer EMLSR Responder, a request to exit the EMLSR over P2P session that comprises an EML Operating Mode Notification frame comprising: an EMLSR mode field that indicates the EML Operating Mode Notification frame corresponds to exiting the EMLSR over P2P session, an EMLSR Parameter Update Control field set to a first value that indicates the first EML Operating Mode Notification frame comprises a request.

In some embodiments, the method 1000 further comprises sending, to the peer EMLSR Responder, an EMLSR over P2P TLV that includes at least one of: an EMLSR over P2P capabilities field that indicates one or more capabilities of the initiator peer device, an EMLSR Link bitmap that indicates one or more links available for, or currently being used for, EMLSR over P2P operation, an EMLSR Responder Unicast AID, or an EMLSR Parameter.

In some embodiments, the method 1000 further comprises entering the EMLSR over P2P session using a single link power save mode with the peer EMLSR Responder.

In some embodiments, the method 1000 further comprises advertising, via a TLV, that to the peer EMLSR Initiator is in an EMLSR over P2P mode, indicating that an other device shall send an initial unicast frame to the EMLSR Responder before a sending data packet.

In some embodiments, the method 1000 further comprises sending a unicast frame to the peer EMLSR Responder, wherein sending the unicast frame comprises: sending a padded muRTS frame comprising: an AID of the EMLSR Responder in a User Info Field, and a padding duration associated with by the EMLSR Responder; receiving a CTS frame in response to the AID being included in the padded muRTS frame; and sending data of the unicast frame.

In some embodiments of the method 1000, sending a multicast frame to the peer EMLSR Responder, wherein sending the multicast frame comprises: sending a padded muRTS frame comprising: a plurality of AIDs, in the User Info Field, corresponding to a plurality of EMLSR Responders, the plurality of AIDs including an AID corresponding to the EMLSR Responder; receiving a CTS frame from the EMLSR Responder; sending multicast data; and engaging in a GCR-BA Sequence with the plurality of EMLSR Responders.

In some embodiments of the method 1000, receiving an update to the EMLSR over P2P session in an EML Operating Mode Notification frame comprising: an EMLSR mode field that indicates the first EML Operating Mode Notification frame corresponds to entering the EMLSR over P2P session, an EMLSR Parameter Update Control field set to a first value that indicates the first EML Operating Mode Notification frame is the request, and an updated parameter.

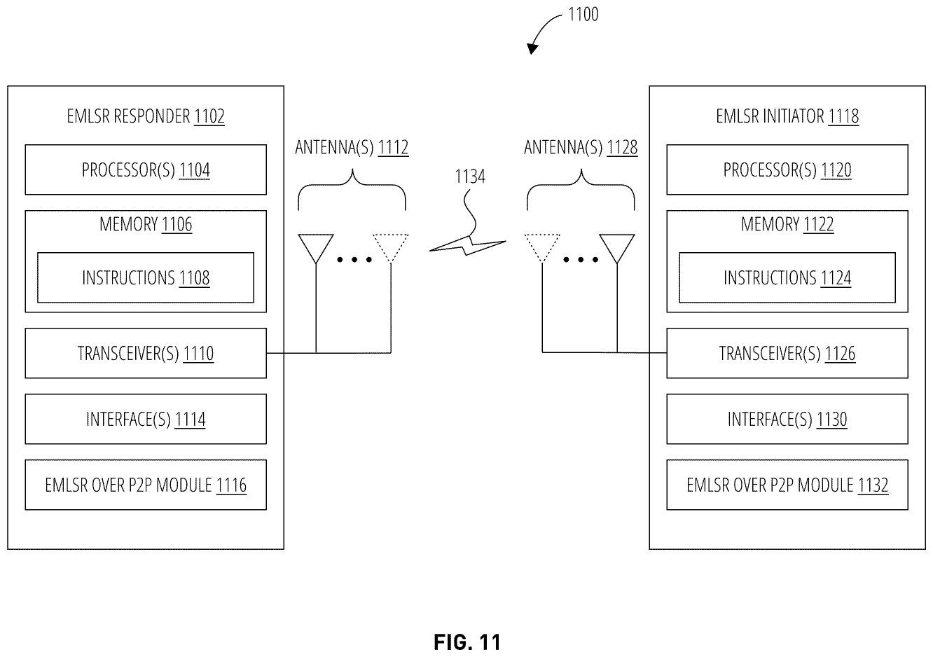

FIG. 11 illustrates a system 1100 for performing signaling 1134 between an EMLSR Responder 1102 and an EMLSR Initiator 1118, according to embodiments disclosed herein. The system 1100 may be a portion of a wireless communications system as herein described. The EMLSR Responder 1102 may be, for example, a UE of a wireless communication system. The EMLSR Initiator 1118 may be, for example, an access point of a wireless communication system.

The EMLSR Responder 1102 may include one or more processor(s) 1104. The processor(s) 1104 may execute instructions such that various operations of the EMLSR Responder 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The EMLSR Responder 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The EMLSR Responder 1102 may include one or more transceiver(s) 1110 that may include radio frequency (RF) transmitter circuitry and/or receiver circuitry that use the antenna(s) 1112 of the EMLSR Responder 1102 to facilitate signaling (e.g., the signaling 1134) to and/or from the EMLSR Responder 1102 with other devices (e.g., the EMLSR Initiator 1118).

The EMLSR Responder 1102 may include one or more antenna(s) 1112 (e.g., one, two, four, or more). For embodiments with multiple antenna(s) 1112, the EMLSR Responder 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the EMLSR Responder 1102 may be accomplished according to precoding (or digital beamforming) that is applied at the EMLSR Responder 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the EMLSR Responder 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The EMLSR Responder 1102 may include one or more interface(s) 1114. The interface(s) 1114 may be used to provide input to or output from the EMLSR Responder 1102. For example, an EMLSR Responder 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The EMLSR Responder 1102 may include an EMLSR over P2P module 1116.

The EMLSR over P2P module 1116 may be implemented via hardware, software, or combinations thereof. For example, the EMLSR over P2P module 1116 may be implemented as a processor, circuit, and/or instructions 1108 stored in the memory 1106 and executed by the processor(s) 1104. In some examples, the EMLSR over P2P module 1116 may be integrated within the processor(s) 1104 and/or the transceiver(s) 1110. For example, the EMLSR over P2P module 1116 may be implemented by a combination of software components (e.g., executed by a DSP or a general processor) and hardware components (e.g., logic gates and circuitry) within the processor(s) 1104 or the transceiver(s) 1110.

The EMLSR over P2P module 1116 may be used for various aspects of the present disclosure, for example, aspects of FIGS. 1-8.

The EMLSR Initiator 1118 may include one or more processor(s) 1120. The processor(s) 1120 may execute instructions such that various operations of the EMLSR Initiator 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The EMLSR Initiator 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The EMLSR Initiator 1118 may include one or more transceiver(s) 1126 that may include RF transmitter circuitry and/or receiver circuitry that use the antenna(s) 1128 of the EMLSR Initiator 1118 to facilitate signaling (e.g., the signaling 1134) to and/or from the EMLSR Initiator 1118 with other devices (e.g., the EMLSR Responder 1102).

The EMLSR Initiator 1118 may include one or more antenna(s) 1128 (e.g., one, two, four, or more). In embodiments having multiple antenna(s) 1128, the EMLSR Initiator 1118 may perform MIMO, digital beamforming, analog beamforming, beam steering, etc., as has been described.

The EMLSR Initiator 1118 may include one or more interface(s) 1130. The interface(s) 1130 may be used to provide input to or output from the EMLSR Initiator 1118. For example, an EMLSR Initiator 1118 may include interface(s) 1130 made up of transmitters, receivers, and other circuitry (e.g., other than the transceiver(s) 1126/antenna(s) 1128 already described) that enables the EMLSR Initiator to communicate with other equipment in a core network, and/or that enables the EMLSR Initiator to communicate with external networks, computers, databases, and the like for purposes of operations, administration, and maintenance of the EMLSR Responder or other equipment operably connected thereto.

The EMLSR Initiator 1118 may include an EMLSR over P2P module 1132. The EMLSR over P2P module 1132 may be implemented via hardware, software, or combinations thereof. For example, the EMLSR over P2P module 1132 may be implemented as a processor, circuit, and/or instructions 1124 stored in the memory 1122 and executed by the processor(s) 1120. In some examples, the EMLSR over P2P module 1132 may be integrated within the processor(s) 1120 and/or the transceiver(s) 1126. For example, the EMLSR over P2P module 1132 may be implemented by a combination of software components (e.g., executed by a DSP or a general processor) and hardware components (e.g., logic gates and circuitry) within the processor(s) 1120 or the transceiver(s) 1126.

The EMLSR over P2P module 1132 may be used for various aspects of the present disclosure, for example, aspects of FIGS. 1-8.

Embodiments contemplated herein include an apparatus comprising means to perform one or more elements of the method 900. This apparatus may be, for example, an apparatus of an EMLSR Responder (such as EMLSR Responder 1102 as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a STA (such as a memory 1306 of an STA 1302, as described herein).

Embodiments contemplated herein include an apparatus comprising logic, modules, or circuitry to perform one or more elements of the method 900. This apparatus may be, for example, an apparatus of an EMLSR Responder (such as EMLSR Responder 1102, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of an EMLSR Responder (such as EMLSR Responder 1102, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of an EMLSR Responder (such as a processor(s) 1104 of an EMLSR Responder 1102, as described herein). These instructions may be, for example, located in the processor and/or on a memory of the STA (such as a memory 1106 of an EMLSR Responder 1102, as described herein).

Embodiments contemplated herein include an apparatus comprising means to perform one or more elements of the method 1000. This apparatus may be, for example, an apparatus of an EMLSR Initiator (such as EMLSR Initiator 1118, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of an EMLSR Initiator (such as a memory 1122 of EMLSR Initiator 1118, as described herein).

Embodiments contemplated herein include an apparatus comprising logic, modules, or circuitry to perform one or more elements of the method 1000. This apparatus may be, for example, an apparatus of an EMLSR Initiator (such as EMLSR Initiator 1118 as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of an EMLSR Initiator (such as EMLSR Initiator 1118, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of an EMLSR Initiator (such as a processor(s) 1120 of EMLSR Initiator 1118, as described herein). These instructions may be, for example, located in the processor and/or on a memory of the EMLSR Initiator (such as a memory 1122 of EMLSR Initiator 1118, as described herein).

For one or more embodiments, at least one of the components set forth in one or more of the preceding figures may be configured to perform one or more operations, techniques, processes, and/or methods as set forth herein. For example, a processor as described herein in connection with one or more of the preceding figures may be configured to operate in accordance with one or more of the examples set forth herein. For another example, circuitry associated with a STA or AP as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems, or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by an Enhanced Multi-Link Single Radio (EMLSR) Responder, the method comprising:
sending, to an initiator peer device, a request to enter an EMLSR over peer-to-peer (P2P) session with the initiator peer device;
receiving, from the initiator peer device, a response accepting the request to enter the EMLSR over P2P session; and
monitoring one or more EMLSR links for at least one of an Initial Control Frame (ICF) with padding or a Request to Send (RTS) from the initiator peer device.

2. The method of claim 1, wherein the request comprises a first Enhanced Multi-Link (EML) Operating Mode Notification frame, the first EML Operating Mode Notification frame comprising:
an EMLSR mode field that indicates the first EML Operating Mode Notification frame corresponds to entering the EMLSR over P2P session,
an EMLSR Parameter Update Control field set to a first value that indicates the first EML Operating Mode Notification frame comprises the request,
an In-Device Coexistence Activities subfield that indicates one or more in-device Coexistence activities on the EMLSR links,
an EMLSR link bitmap,
a padding delay field, and
a transition delay field.

3. The method of claim 2, wherein the response comprises a second EML Operating Mode Notification frame comprising:
an EMLSR mode field that indicates the first EML Operating Mode Notification frame corresponds to entering the EMLSR over P2P session, and
an EMLSR Parameter Update Control field set to a second value that indicates the second EML Operating Mode Notification frame comprises the response.

4. The method of claim 1, further comprising sending, to the initiator peer device, a request to exit the EMLSR over P2P session that comprises an EML Operating Mode Notification frame comprising:
an EMLSR mode field that indicates the EML Operating Mode Notification frame corresponds to exiting the EMLSR over P2P session,
an EMLSR Parameter Update Control field set to a first value that indicates the first EML Operating Mode Notification frame comprises a request.

5. The method of claim 1, further comprising, receiving from the initiator peer device an EMLSR over P2P Type-Length-Value (TLV) that includes at least one of:
an EMLSR over P2P capabilities field that indicates one or more capabilities of the initiator peer device,
an EMLSR Link BitMap that indicates one or more links available for, or currently being used for, EMLSR over P2P operation,
an EMLSR Responder Unicast Association Identifier (AID), or
an EMLSR Parameter.

6. The method of claim 1, further comprising entering the EMLSR over P2P session using a single link power save mode with the initiator peer device.

7. The method of claim 1, further comprising advertising, via a Type-Length-Value (TLV), that the EMLSR responder is in an EMLSR over P2P mode, indicating that an other device shall send an initial unicast frame to the EMLSR Responder before sending a data packet.

8. The method of claim 1, further comprising:
receiving a unicast frame from the initiator peer device, wherein receiving the unicast frame comprises:
receiving, from the initiator peer device, a padded Multi-User Request to Send (muRTS) frame comprising:
an Association Identifier (AID) of the EMLSR Responder in a User Info Field, and
a padding duration associated with the EMLSR Responder;
sending, to the initiator peer device, a Clear to Send (CTS) frame in response to the AID being included in the padded muRTS frame; and
receiving, from the initiator peer device, data of the unicast frame.

9. The method of claim 1, receiving a multicast frame from the initiator peer device, wherein receiving the multicast frame comprises:
receiving, from the initiator peer device, a padded Multi-User Request to Send (muRTS) frame comprising:
a plurality of AIDs, in the User Info Field, corresponding to a plurality of EMLSR Responders;
sending, to the initiator peer device, a Clear to Send (CTS) frame in response to an AID corresponding to the EMLSR Responder being included in the plurality of AIDs; and
receiving, from the initiator peer device, multicast data.

10. The method of claim 1, updating the EMLSR over P2P session by sending an Enhanced Multi-Link (EML) Operating Mode Notification frame comprising:
an EMLSR mode field that indicates the first EML Operating Mode Notification frame corresponds to entering the EMLSR over P2P session,
an EMLSR Parameter Update Control field set to a first value that indicates the first EML Operating Mode Notification frame is the request, and
an updated parameter.

11. A method performed by an Enhanced Multi-Link Single Radio (EMLSR) Initiator, the method comprising:
receiving, from a peer EMLSR responder, a request to enter an EMLSR over peer-to-peer (P2P) session with the peer EMLSR Responder;
sending, to the peer EMLSR Responder, a response accepting the request to enter the EMLSR over P2P session; and
sending, via one or more EMLSR links, at least one of an Initial Control Frame (ICF) with padding or a Request to Send (RTS) to the peer EMLSR Responder to initiate a transmission opportunity.

12. The method of claim 11, wherein the request comprises a first Enhanced Multi-Link (EML) Operating Mode Notification frame, the first EML Operating Mode Notification frame comprising:
an EMLSR mode field that indicates the first EML Operating Mode Notification frame corresponds to entering the EMLSR over P2P session,
an EMLSR Parameter Update Control field set to a first value that indicates the first EML Operating Mode Notification frame comprises the request,
an In-Device Coexistence Activities subfield that indicates one or more in-device Coexistence activities on the EMLSR links,
an EMLSR link bitmap,
a padding delay field, and
a transition delay field.

13. The method of claim 12, wherein the response comprises a second EML Operating Mode Notification frame comprising:
an EMLSR mode field that indicates the first EML Operating Mode Notification frame corresponds to entering the EMLSR over P2P session, and
an EMLSR Parameter Update Control field set to a second value that indicates the second EML Operating Mode Notification frame comprises the response.

14. The method of claim 11, further comprising receiving, from the peer EMLSR Responder, a request to exit the EMLSR over P2P session that comprises an EML Operating Mode Notification frame comprising:
an EMLSR mode field that indicates the EML Operating Mode Notification frame corresponds to exiting the EMLSR over P2P session,
an EMLSR Parameter Update Control field set to a first value that indicates the first EML Operating Mode Notification frame comprises a request.

15. The method of claim 11, further comprising, sending, to the peer EMLSR Responder, an EMLSR over P2P Type-Length-Value (TLV) that includes at least one of:
an EMLSR over P2P capabilities field that indicates one or more capabilities of the initiator peer device,
an EMLSR Link BitMap that indicates one or more links available for, or currently being used for, EMLSR over P2P operation,
an EMLSR Responder Unicast Association Identifier (AID), or
an EMLSR Parameter.

16. The method of claim 11, further comprising entering the EMLSR over P2P session using a single link power save mode with the peer EMLSR Responder.

17. The method of claim 11, further comprising advertising, via a Type-Length-Value (TLV), that to the peer EMLSR Initiator is in an EMLSR over P2P mode, indicating that an other device shall send an initial unicast frame to the EMLSR Responder before sending a data packet.

18. The method of claim 11, further comprising:
sending a unicast frame to the peer EMLSR Responder, wherein sending the unicast frame comprises:
sending a padded Multi-User Request to Send (muRTS) frame comprising:
an Association Identifier (AID) of the EMLSR Responder in a User Info Field, and
a padding duration associated with the EMLSR Responder;
receiving a Clear to Send (CTS) frame in response to the AID being included in the padded muRTS frame; and
sending data of the unicast frame.

19. The method of claim 11, sending a multicast frame to the peer EMLSR Responder, wherein sending the multicast frame comprises:
sending a padded Multi-User Request to Send (muRTS) frame comprising:
a plurality of AIDs, in the User Info Field, corresponding to a plurality of EMLSR Responders, the plurality of AIDs including an AID corresponding to the EMLSR Responder;
receiving a Clear to Send (CTS) frame from the EMLSR Responder;
sending multicast data; and
engaging in a Groupcast with Retries Block Acknowledgment (GCR-BA) Sequence with the plurality of EMLSR Responders.

20. The method of claim 11, receiving an update to the EMLSR over P2P session in an Enhanced Multi-Link (EML) Operating Mode Notification frame comprising:
an EMLSR mode field that indicates the first EML Operating Mode Notification frame corresponds to entering the EMLSR over P2P session,
an EMLSR Parameter Update Control field set to a first value that indicates the first EML Operating Mode Notification frame is the request, and
an updated parameter.
